(19) United States
(12) Patent Application Publication
(10) Pub. No.: US 2008/0263045 A1
(43) Pub. Date: Oct. 23, 2008

(54) MULTI-TIERED SECURED INFORMATION HUB

(75) Inventors: Jesus Soto, San Antonio, TX (US); Brian Kyle Phillips, Douglass, KS (US)

Correspondence Address: HOVEY WILLIAMS LLP, 10801 Mastin Blvd., Suite 1000, Overland Park, KS, 66210, US

(73) Assignee: SOPHI INDUSTRIES LLC, Douglass, KS (US)

(21) Appl. No.: 11/737,534

(22) Filed: Apr. 19, 2007

(51) Int. Cl. G06F 21/22

(52) U.S. Cl. 707/9

(57) ABSTRACT

A multi-tiered, secured information hub includes a plurality of information folders each containing information provided by an account owner. An Manage Account section permits the account owner to designate authorized users who have permission to access the information hub and to designate which portions of the information can be viewed by each of the authorized users. A timed window access limitation may be applied to some of the information so that authorized users can only view the information for a limited time period. A tracking section date and time stamps all information as it is added to the information hub and monitors and records the authorized users' access and use of the hub.

### BACKGROUND

1. Field

The present invention relates to Internet-accessible information hubs. More particularly, the invention relates to a secured information hub for posting confidential and personal information.

2. Description of the Related Art

People frequently must provide detailed personal, financial, legal, and other confidential information to service professionals such as attorneys, mortgage brokers, and accountants in order to obtain mortgages, buy real estate, file tax returns, etc. People typically keep such information in digital or paper files and provide it to the service professionals on an as-needed basis. Unfortunately, gathering and providing detailed information each time it is needed can be very tedious and time-consuming, especially for people who frequently hire service professionals and/or are away from their homes for extended periods of time such as active duty soldiers.

People also often gather personal information about themselves and their families such as photos, schedules, school records, etc. and send the information to friends and family. Again, repeatedly gathering and sending information in this manner can be tedious and time-consuming.

Social networks such as MySpace® allow people to gather and post personal and other information on the Internet so that others can access and view the information. However, because social networks can be accessed by anyone, they are often not suitable for posting financial, legal, and other confidential or personal information.

### SUMMARY

The present invention solves the above-described problems and provides a distinct advance in the art of social networks and information hubs. More particularly, embodiments of the invention provide an information hub that can be safely and conveniently used to post confidential and personal information for viewing by others.

The present invention can be implemented in many different ways. In an exemplary embodiment, the invention is implemented with a computer program or programs that operate computer equipment including a host computer and a plurality of computing devices that may access the host computer via the Internet or another communications network, to include handheld devices such as PDAs, all-in-one cell phones, laptops, etc.

The computer programs enable a multi-tiered, secured information hub which includes a plurality of information folders each containing information provided by an account owner. The account owner may, for example, place scheduling information in a Calendar folder, contact information in an Emergency Contacts folder, and financial information in a Financial folder. The information hub may also include an Account Management section which permits the account owner to designate people who have permission to access the information hub (authorized users) and to designate which portions of the information can be viewed by each of the authorized users. For example, an account owner may designate both an attorney and a military records person as authorized users and then give the attorney access to all legal and financial information on the hub and the military records person access to emergency contact information only.

The Account Management section may also permit the account owner to apply a timed window access limitation to some of the posted information so that authorized users can only view the information for a limited time period (e.g. 4 hours, 1 week, etc.). The information hub may also include an upload section for permitting at least one of the authorized users to upload additional information to the information hub. The hub may further include a tracking section for date and time stamping all information as it is added to the information hub and for monitoring and recording the authorized users' access and specific use of the hub.

The tracking section may also monitor which of the information folders the account owner accessed last before disconnecting from the information hub. At the user's discretion upon logging in, and within the tracking section features, the account user may return to the last place the user was working on within their account when previously logged in. In some embodiments, the user may be directed back to the last place he or she was working by simply selecting one button or link (one-click). This permits the account owner to upload information whenever it is convenient and then quickly and easily add more information to the same location within the account at a later date.

These and other important aspects of the present invention are described more fully in the detailed description below.

### BRIEF DESCRIPTION OF THE DRAWING FIGURES

Preferred embodiments of the present invention are described in detail below with reference to the attached drawing figures, wherein:

FIG. 1 is a schematic diagram of exemplary computer and communications equipment which may be used to implement embodiments of the present invention;

FIG. 2 is a site map or block diagram of an exemplary information hub;

FIG. 3 is a table illustrating an account management section of the information hub; and

FIG. 4 is a flow chart depicting the functionality and operation of a preferred implementation of the information hub.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

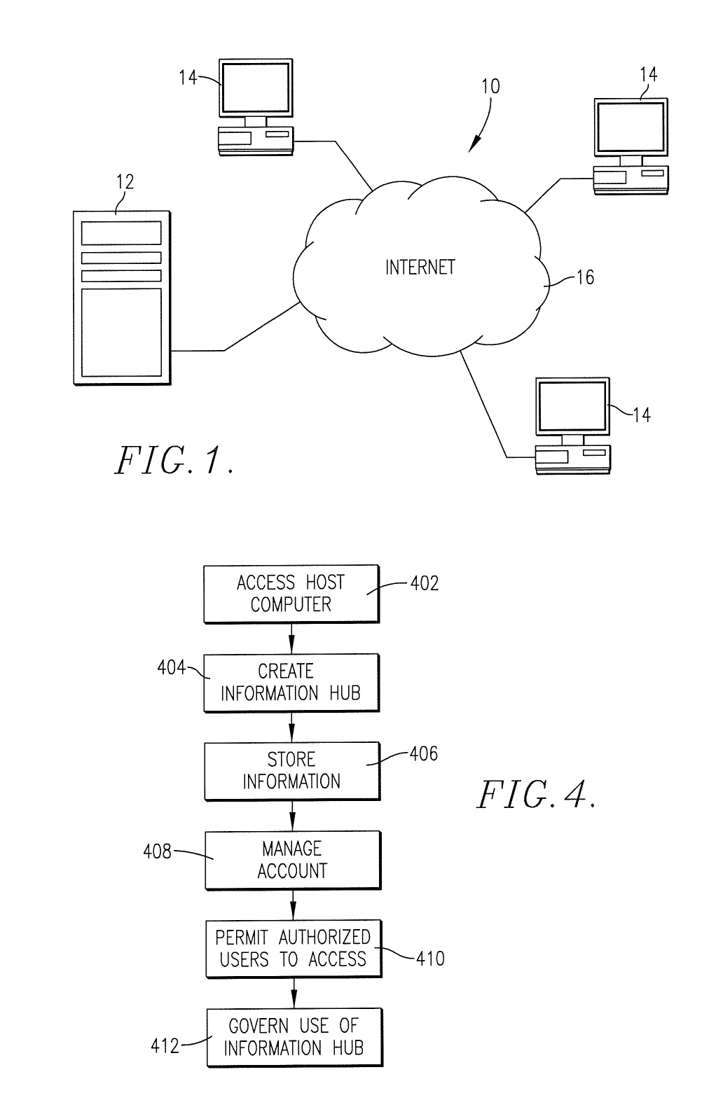

The present invention can be implemented in many different manners. In an exemplary embodiment, the invention is implemented with a computer program or programs that operate a website or other site that is hosted by and can be accessed with computer equipment broadly referred to by the numeral 10 in FIG. 1. The computer equipment 10 may include a host computer 12 and a plurality of computing devices 14 that can access the host computer 12 via a communications network 16. The computer programs and equipment illustrated and described herein are merely examples of programs and equipment that may be used to implement embodiments of the present invention and may be replaced with other software and computer equipment without departing from the scope of the present invention.

The host computer or server 12 operates or hosts the website or other site and serves as a repository for data and programs used to implement certain aspects of the present invention as described in more detail below. The host computer or server 12 may be any computing device such as a network computer running Windows XP, Windows Vista, Windows NT, Novel Netware, Unix, or any other network operating system. The host computer or server 12 may be connected to a firewall to prevent tampering with information stored on or accessible by the host computer or server 12 and to computing devices operated by administrators of the host computer. The host computer or server 12 includes conventional web hosting operating software, an Internet connection such as a modem, DSL converter or ISDN converter, and is assigned a URL so that the website hosted thereon can be accessed via the Internet in a conventional manner.

The computing devices 14 may be any types of devices that permit access to the host computer or server 12 via the communications network 16. For example, the computing devices may include personal computers such as those manufactured and sold by Dell, Compaq, Gateway, or any other computer manufacturer, handheld personal assistants such as those manufactured and sold by Palm or Pilot, or even Internet appliances that are specifically designed for accessing the Internet. Each computing device 14 preferably includes or can access a conventional Internet connection such as a modem, DSL converter, or ISDN converter and a web browser that permits it to access the Internet. The computing devices 14 may be used by anyone who wishes to access the information hub stored on the host computer.

The communications network 16 is preferably the Internet but may be any other conventional communications network such as a local area network, a wide area network, a wireless network, or an intranet.

The computer program or programs of the present invention are stored in or on computer-readable medium residing on or accessible by the host computer or server 12 for instructing the host computer to implement the functions and features as described herein. The computer programs each comprise an ordered listing of executable instructions for implementing logical functions in the host computer or server 12 and/or computing devices 14. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The computer programs may enable a multi-tiered secured information hub which includes a plurality of information folders each containing information provided by an account owner. Some or all of the aspects of the information hub may be implemented with Microsoft® SharePoint or similar programs. The information hub may include an Account Management section which permits the account owner to designate authorized users who have permission to access the information hub and to designate which portions of the information can be viewed by each of the authorized users. A secured access only grants access to the authorized users and permits each of the authorized users to view only designated portions of information.

The Account Management section may also permit the account owner to apply a timed window access limitation to some of the posted information so that authorized users can only view the information for a limited time period. An upload section permits at least one of the authorized users to upload additional information to the information hub. The hub may further include a tracking section for date and time stamping all information as it is added to the information hub. The tracking section may also monitor which of the information folders the account owner accessed last before disconnecting from the information hub in order to navigate the account owner to the same folder when the account owner re-connects to the information hub.

The flow chart of FIG. 4 shows the functionality and operation of an exemplary implementation of the present invention in more detail. In this regard, some of the blocks of the flow chart may represent a module segment or portion of code of the computer programs of the present invention which comprises one or more executable instructions for implementing the specified logical function or functions. In some alternative implementations, the functions noted in the various blocks may occur out of the order depicted in FIG. 4. For example, two blocks shown in succession in FIG. 4 may in fact be executed substantially concurrently, or the blocks may sometimes be executed in the reverse order depending upon the functionality involved.

A person (sometimes referred to herein as “account owner”) who wishes to create an information hub first accesses the host computer or server 12 using one of the computing devices 14 and the communication network 16 as depicted in step 402. The first time the host computer is accessed, the account owner may be required to set-up an account, pick a user ID and password, and pay a subscription or membership fee. The host computer or server 12 may host multiple information hubs for different account owners, but only one information hub for a single account owner is discussed below.

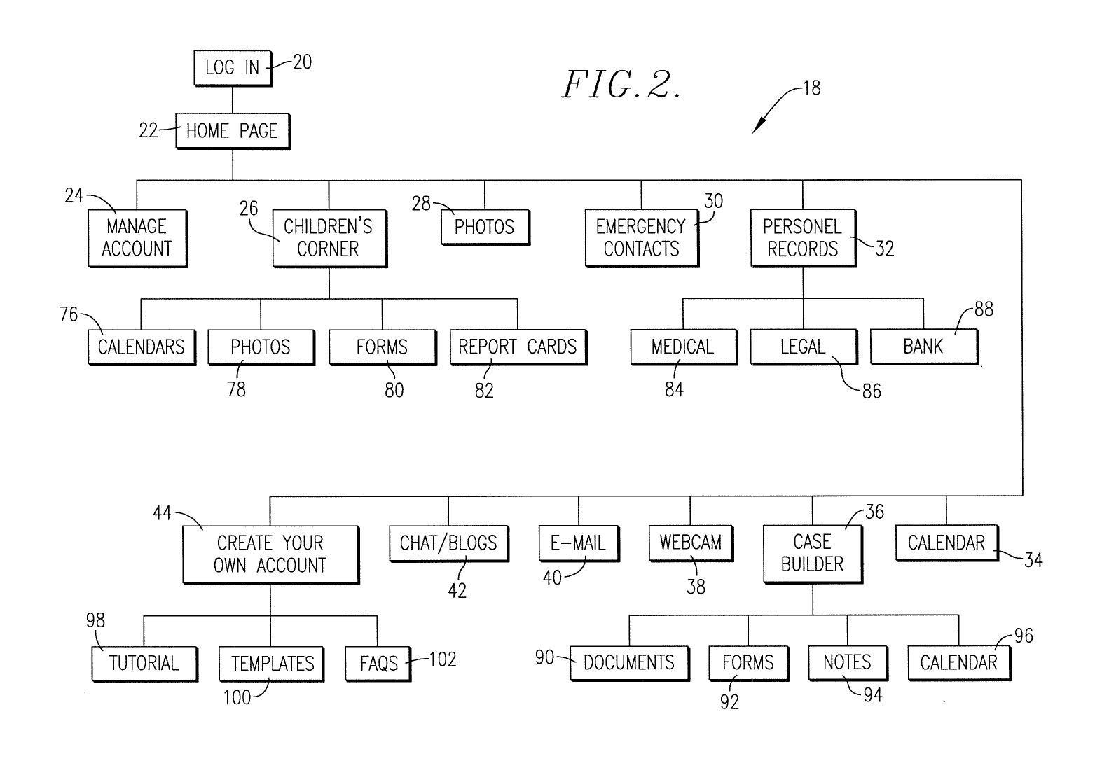

The account owner then creates and/or personalizes a personal information hub in which to post information as depicted in step 404. The host computer or server 12 may provide templates or samples for creating the hub and/or may provide instructions or other guidance. The information hub may include a number of sections, information folders, or databases for posting different types of information. For example, FIG. 2 depicts an exemplary information hub 18 having a Log-in section 20, a Home Page 22, a Manage Account section 24, and the following information folders: Children's Corner 26, Photos 28, Emergency Contacts 30, Personal Records 32, Calendars 34, Case Builder 36, Web Cam 38, E-mail 40, and Chat/Blogs 42. The information hub may also include a Create Your Own Account section 44. These are only examples of possible sections, folders, etc., and the invention is not limited to any particular examples described herein.

The Log-in section 20 is displayed whenever the account owner or others connect to the host computer or server 12 and attempt to access information on the information hub 18. As described in more detail below, the Log-in section 20 requires the entry of a valid ID, password, and possibly other information before granting access to the information in the information hub.

The Home Page 22 is displayed after a valid ID and password have been entered. The Home Page may include graphics, artwork, photos, and other identifying information selected by the account owner as well as tabs or other links for all of the sections and file folders 24-44. The account owner may even select different Home Pages for display to different authorized users. For example, the account owner may select a more formal Home Page for service professionals and a more informal Home Page for family members and friends.

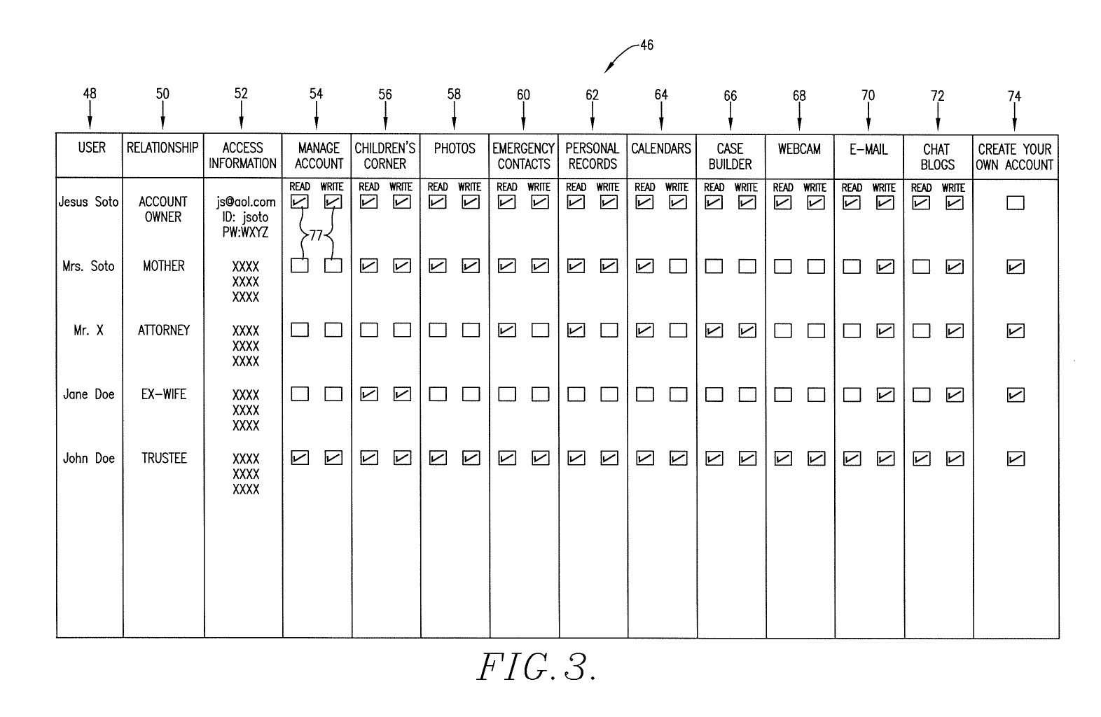

The Manage Account section 24 permits the account owner to manage all aspects of his or her information hub 18 including who may access the hub and what information may be viewed by each person. To do so, the Manage Account section may display a table or database 46 similar to the one illustrated in FIG. 3.

The first column 48 of the table 46 may list all people who are authorized to access the information hub. For example, the exemplary table in FIG. 3 lists the account owner, Jesus Soto, and four authorized users. The second column 50 may list the identity or relationship of the users and the third column 52 may list each user's e-mail address, ID, and password. The Log-in section may refer to this table when determining whether a person is an authorized user or the information in the table may be provided to the Log-in section in other ways.

The remaining columns 54, 56, 58, 60, 62, 64, 66, 68, 70, 72, 74 allow the account owner to designate which of the sections or information folders can be accessed by which users by checking boxes 77 under each information folder. These columns may also permit the account owner to designate whether the authorized users have Read and/or Write permission for the folders. For example, FIG. 3 shows that Jesus Soto, the account owner, has Read and Write privileges for all the information folders; and Mrs. Soto has Read and Write privileges for the Children's Corner, Photos, and Emergency Contacts folders, Read privileges only for the Personal Records and Calendars folders, and Write privileges only for E-mail and Chat/Blogs folders.

At any time, the account owner may access the Manage Account section 24 to add new authorized users, delete existing authorized users, and/or change any of the permission levels. For example, if the account owner wants to give Mr. X, his attorney, Read privileges to his Personal Records information folder, the account owner may access the Manage Account table 46 shown in FIG. 3 and check the Read box in column 8 under the heading Personal Records.

During or after creation of the information hub 18, the account owner may store information in any of the file folders 26-42. To do so, the account owner simply accesses the host computer or server 12 with one of the computing devices 14 via the communications network 16 and logs-in as discussed above. The owner may then select a tab corresponding to an information folder from the Home Page 22 to be directed to the folder. The owner may then enter, upload, or otherwise add any desired information to the folder. All of the information in the information hub is backed-up regularly and may even be archived.

The host computer or server 12 and computing device 14 used by the account owner may also be configured to permit the account owner to enter information into a queue or other memory on the computing device 14 while the computing device 14 is not in communication with the host computer or server 12 and to upload the information to the host computer the next time the computing device is connected to the host computer. This permits people who are frequently without Internet access, such as active duty soldiers, to continue working on their information hubs even while they are off-line.

Information is preferably stored in several different information folders as discussed above so that the account owner may organize the information and selectively grant access to the information. Referring again to the exemplary information hub 18 shown in FIG. 2, the Children's Corner information folder 26 may be used for posting information about the account owner's children including calendars for school and sporting activities, photos, school and medical forms, and report cards. Thus, the folder 26 may have sub-folders for Calendars 76, Photos, 78, Forms 80, and Report Cards 82. The main folder 26 or sub-folders 76, 78, 80, 82 may be linked to a child's school web site so that certain forms may be obtained from the school web site. The calendars in the Children's Corner section may include both a parent mode and a child mode so that certain scheduling information is only displayed to parents an other information is only displayed to children.

The Photos folder 28 may be used for posting photos uploaded by the account owner or authorized users. The Emergency Contacts folder 30 may be used for posting the account owner's phone numbers, addresses, e-mail addresses, etc. This folder may also list people to contact in case of an emergency such as the account owner's spouse, parents, attorney, etc. The Personal Records folder 32 may be used for posting electronic copies of medical records, legal records, bank records, insurance records, birth certificates, passports, and other similar records and documents. Thus, the folder 32 may have sub-folders for Medical 84, Legal 86, and Bank 88 documents.

The Calendars folder 34 may be used for posting one or more calendars or schedules. The calendars may have access restrictions so that certain dates or events can only be seen by selected authorized users. Activities shown in the calendars may be designated by icons such as an icon of a schoolhouse for school events. The calendars may also include comment boxes for receiving comments from authorized users such as proposed doctor's or dentist's appointments. The host computer may also only display calendar events of interest to the authorized users. For example, if an authorized user only wants to learn about school activity schedules, the host computer may only display these events on the calendar.

The calendars may also have a time stamp feature which tracks the creation date, modification date, and creates for each entry the calendars. A pop-up window may be displayed to show this tracking information whenever a user places a cursor over a calendar entry. One or more of the calendars in this section may be linked to the calendars in the Children's Corner to synchronize scheduling between the calendars.

In accordance with one important aspect of the present invention, the Case Builder folder 36 may be used by the account owner and a legal professional such as an attorney to assist with a professional service or task such as a divorce proceeding. Information and/or documents relevant to a particular legal proceeding such as a pending divorce may be posted to this folder. For example, the Case Builder folder may have sub-folders for Documents 90, Forms 92, Notes 94, and Calendars 96. The Case Builder folder 36 may also include a legal research section that permits the account owner and/or an attorney to access legal research tools such as Westlaw. The folder 36 may also include a billing section that permits the account owner an/or attorney to access a conventional attorney billing program for recording the time spent on a legal proceeding and to generate corresponding bills. The Case Builder folder 36 and/or the sub-folders 90, 92, 94, 96 may be linked to court web sites and electronic filing systems so that documents can be obtained from or filed with the courts.

The Web Cam section 38 may be linked to one or more cameras that are connected to the host computer or server 12 via the Internet 16 or other communications network. For example, the Web Cam section may be linked to a home security camera and a web cam attached to the account user's computing device. The account owner or an authorized user may access this folder to view real-time or stored images generated by the camera.

The E-mail folder 40 provides conventional e-mail messaging capabilities and may be linked to a conventional e-mailing program such as Microsoft Outlook®. Similarly, the Chat/Blogs folder 42 provides conventional chat/blogging capabilities and may be linked to conventional chat rooms or blog sites.

The last column 74 allows users to navigate to an Account Creation section 44 so they may create their own information hubs. As explained above, the host computer or server 12 may provide templates, samples, or other guidance for creating new information hubs. The Account Creation section 44 may include sub-folders containing a Tutorial 98, Templates 100, and Frequently Asked Questions (FAQs) 102.

As information is added to any of these folders, the account owner may continue to manage the account as depicted in step 408. For example, the account owner may grant Read and/or Write privileges for information as it is added or may enable a Decide Later feature to mark the added information for later determination. Information that has been recently added (e.g. during the most recent 24-hour period) may also be saved in a Recent Updates folder so that users can quickly and easily access the new information.

Once the information hub 18 has been created and information has been added, the account owner may permit authorized users to access the hub as shown in step 410. The authorized users may do so by accessing the host computer or server 12 via the Internet or other communications network 16 with one of the computing devices 14 and then entering the required log-in information. The authorized users may be any persons or entities granted access rights by the account owner including family members, doctors, attorneys, teachers, dentists, therapists, coaches, police officers, social workers, or anyone else who the account owner may wish to share information with.

In accordance with one important aspect of the present invention, the account owner may apply a timed window access limitation to some of the information in the information hub 18. The timed window access permits authorized users to view selected information only for a limited time (e.g. 4 hours). The timed window access may be applied to the information hub as a whole, individual information folders within the information hub, and even particular information within each folder. An account owner may, for example, post highly confidential financial information and then permit his accountant to access the information for one week so that the accountant may prepare the account owner's tax returns.

The host computer or server 12 may also permit authorized users to upload information to the information hub. Only those authorized users who have Write capabilities as discussed above may upload information, and they may only upload information to the information folders designated by the account owner. For example, referring to FIG. 3, Mr. X, the account owner's attorney, is permitted to upload information to the Case Builder. Information added by an authorized user may be automatically added to the relevant information folder so that it may be immediately accessed by all authorized users who have Read privileges to the folder or the added information may be initially stored in an Upload folder so that it can be viewed by the account owner and selectively added to the relevant information folders.

The information hub 18 may also include a tracking feature which monitors the account owner's and the authorized users' use of the information hub. The tracking feature may record the last information folder accessed and then navigate the account owner or the authorized users to this information folder when they reconnect to the information hub. This permits the account owner to add information to a particular information folder whenever it is convenient and quickly and easily add more information to the same folder at a later date. This feature is especially useful for active duty soldiers who may only be able to access the information hub for short intervals at random times.

The information hub 18 may also include a Statistics section that enables the account owner and authorized users to create graphs, statistics, etc. based on the information in the information hub or the users' access of the hub. For example, the Statistics section may permit the account owner to create a graph or other visual aid that shows how often and how long each information folder is viewed. The account owner and/or an administrator of the host computer may use this statistical information to encourage the addition of popular information to an information hub.

The computing device 14 operated by the account owner may also include a GPS receiver, or be coupled to a stand-alone GPS receiver, to track the account owner's current location. Data corresponding to the location may then be uploaded to the information hub and shown superimposed on a map so that authorized users may access the information hub to determine the account owner's current whereabouts.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A computer program stored on a computer-readable medium for implementing a secured information hub, the computer program comprising:
a code segment for permitting an account owner to add information to the information hub;
a code segment for permitting the account owner to designate authorized users who have permission to access the information in the information hub;
a code segment for permitting the account owner to designate which portions of the information may be viewed by each of the authorized users;
a code segment for granting the authorized users access to the information hub and for refusing access to others; and
a code segment for permitting each of the authorized users to view only the portions of the information which have been designated for each of the authorized users by the account owner.

2. The computer program as set forth in claim 1, further including a code segment for permitting the account owner to apply a timed window access limitation to some of the information stored in the information hub.

3. The computer program as set forth in claim 2, further including a code segment for limiting the authorized users' viewing of some of the information in accordance with the timed window access limitation.

4. The computer program as set forth in claim 2, further including a code segment for permitting the account owner to select a time period for the timed window access.

5. The computer program as set forth in claim 1, further including a code segment for permitting at least one of the authorized users to upload additional information to the information hub.

6. The computer program as set forth in claim 5, further including a code segment for date and time stamping the information and the additional information as it is added to the information hub.

7. The computer program as set forth in claim 1, wherein the information hub is stored on a server computer and accessible by the authorized users and the account owner via the Internet.

8. The computer program as set forth in claim 1, further including a code segment for permitting the account owner to create multiple information folders for storing different types of information on the information hub.

9. The computer program as set forth in claim 8, further including a code segment for monitoring and recording which of the information folders the account owner accessed last before disconnecting from the information hub and for navigating the account owner to the information folder accessed last when the account owner re-connects to the information hub.

10. A method of implementing a secured information hub accessible via the Internet, the method comprising the steps:
permitting an account owner to add information to the information hub;
permitting the account owner to designate authorized users who have permission to access the information hub;
permitting the account owner to designate which portions of the information may be viewed by each of the authorized users;
granting the authorized users access to the information hub and refusing access to others; and
allowing each of the authorized users to view only the portions of the information which have been designated for each of the authorized users by the account owner.

11. The method as set forth in claim 10, further including the step of permitting the account owner to apply a timed window access limitation to some of the information stored in the information hub.

12. The method as set forth in claim 10, further including the step of limiting the authorized users' viewing of some of the information in accordance with the timed window access limitation.

13. The method as set forth in claim 10, further including the step of permitting at least one of the authorized users to upload additional information to the information hub.

14. The method as set forth in claim 13, further including the step of date and time stamping the information and the additional information as it is added to the information hub.

15. The method as set forth in claim 10, further including the steps of permitting the account owner to create multiple information folders and storing different types of information in each of the information folders.

16. The method as set forth in claim 15, further including the step of monitoring which of the information folders the account owner accessed last before disconnecting from the information hub and for navigating the account owner to the information folder accessed last when the account owner re-connects to the information hub.

17. A multi-tiered secured information hub stored on a server computer and accessible via the Internet, the information hub comprising:
a plurality of information folders each containing information provided by an account owner;
an Manage Account section which permits the account owner to designate authorized users who have permission to access the information hub and to designate which portions of the information can be viewed by each of the authorized users; and
a secured access for granting the authorized users access to the information hub and for refusing access to others and for permitting each of the authorized users to view only the portions of information designated for each of the authorized users by the account owner.

18. The multi-tiered information hub as set forth in claim 17, the Manage Account section further permitting the account owner to apply a timed window access limitation to some of the information stored in the information hub.

19. The multi-tiered information hub as set forth in claim 17, further including an upload section for permitting at least one of the authorized users to upload additional information to the information hub.

20. The multi-tiered information hub as set forth in claim 19, further including a tracking section for date and time stamping the information and the additional information as it is added to the information hub.

21. The multi-tiered information hub as set forth in claim 17, the Manage Account section permitting the account owner to create multiple information folders and for storing different types of information in the information folders.

22. The multi-tiered information hub as set forth in claim 21, further including a tracking section for monitoring which of the information folders the account owner accessed last before disconnecting from the information hub and for navigating the account owner to the information folder accessed last when the account owner re-connects to the information hub.
